(19) United States
(12) Patent Application Publication
(10) Pub. No.: US 2010/0254692 A1
(43) Pub. Date: Oct. 7, 2010

(54) CAMERA ILLUMINATION DEVICE

(75) Inventors: Ralph Kurt, Eindhoven (NL); Eduard Johannes Meijer, Eindhoven (NL); Dragan Sekulovski, Eindhoven (NL); Ingrid Maria Laurentia Cornelia Vogels, Eindhoven (NL); Herbert Lifka, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/746,769

(22) PCT Filed: Dec. 8, 2008
(86) PCT No.: PCT/IB08/55133

§ 371 Date: Jun. 8, 2010

(30) Foreign Application Priority Data
Dec. 11, 2007 (EP) 07122892.8

(51) Int. Cl. G03B 15/03

(52) U.S. Cl. 396/155

(57) ABSTRACT

The present invention relates to a method for illuminating a scene having an average lighting setting, the method comprising the steps of receive scene information from an image sensor (110) comprising a plurality of pixels, determine chromaticity coordinates for the scene based on the scene information, and determine, based on the chromaticity coordinates, control values used for driving the at least two differently colored light sources (L₁, L₂, L₃), thereby allowing for illumination of the scene without essentially changing the average lighting setting of the scene. The present invention provides for the possibility to in a more precise way match the average lighting setting of the scene, wherein it is possible to produced light that assure a more natural rendering of illuminated objects in the scene. In comparison to the prior art, for light sources which have spectra far from the black body curve, the chromaticity coordinates are a better representation of the color of ambient light illuminating the scene than when using the correlated color temperature. The present invention also relates to a corresponding illumination device (100).

### FIELD OF THE INVENTION

The present invention relates to a method for illuminating a scene. The present invention also relates to a corresponding illumination device for illuminating a scene.

### DESCRIPTION OF THE RELATED ART

A camera flash is a device that produces an instantaneous flash of artificial light (typically around 1/3000 of a second) at a color temperature of about 5500 K to help illuminate a scene. While flashes can be used for a variety of reasons (e.g. capturing quickly moving objects, creating a different temperature light than the ambient light) they are mostly used to illuminate scenes that do not have enough available light to adequately expose the photograph.

A big drawback with using a camera flash is that the color temperature of the flash is in principle fixed. As a result, the light used when taking the picture mainly originates from the flashlight. This means that in a scene with a color temperature diverging from the fixed color temperature of the flash, e.g. a Christmas dinner with warm candle light, is not represented in the same way in the photograph as compared to how the scene was experienced at the time of capturing the photography. In essence, it is essentially impossible to accurately capture the atmosphere of a scene with a flash that has a fixed color temperature. One way of solving this is by increasing the shutter time of the camera and not use a flash, but it is preferred to keep the shutter time short due to a number of reasons known by the skilled addressee. Another way of solving the problem is by using a flash emitting light having adjustable color temperature.

Examples of flash devices emitting light having adjustable color temperature comprise fixed additional lights as used by photographers or video maker, where the color temperature of the light emitted by the flash is adjusted artificially, for example by applying different types of filters, such as a sunset or a chrome filter. However, to manually change the filters is undesirable, at the same time as a large plurality of filters is needed, which results in an expensive end product.

An example of an implementation trying to overcome this problem is disclosed in U.S. 2005/0134723, providing an image acquisition system comprising a camera and a lighting module comprising a plurality of differently colored light emitting diodes (LEDs). The lighting module is adapted to illuminate a scene with light having essentially the same color temperature as the color temperature of the ambient light illuminating the scene. However, the disclosed image acquisition system fails to provide adequate accuracy in relation to the matching of the color temperature of the scene as using only the color temperature of the scene will give a good estimate only under very strict assumptions, for example in the case where the color or all the objects in the scene or part of the scene used for color temperature estimation average to a neutral gray, i.e. gray world assumption, or when using special neutral grey targets.

### OBJECT OF THE INVENTION

There is therefore a need for an improved method for illuminating a scene having an average lighting setting which at least alleviate the problems according to the prior art, while providing further improvements in terms of accuracy and adaptability.

### SUMMARY OF THE INVENTION

According to an aspect of the invention, the above object is met by a method for illuminating a scene having an average lighting setting, the method comprising the steps of receive scene information from an image sensor comprising a plurality of pixels, determine chromaticity coordinates for the scene based on the scene information, and determine, based on the chromaticity coordinates, control values used for driving the at least two differently colored light sources, thereby allowing for illumination of the scene without essentially changing the average lighting setting of the scene.

The expression scene information is according to the invention understood to mean at least, but not exclusively, the intensity and characteristics of the artificial light illuminating the scene. The scene information can however also comprise objects detected in the scene, such as for example detecting a person present in the scene. Generally, that scene information is a digital representation of the intensity and possibly the colors of the scene, and/or an object of interest in the scene.

The present invention provides for the possibility to in a more precise way match the average lighting setting of the scene, wherein it is possible to produced light that assure a more natural rendering of illuminated objects in the scene. Prior art methods uses only correlated color temperature as a target for the scene illumination, and for traditional lighting (day light, incandescent), this is sufficient because the chromaticity of such light sources is close to the black body curve. However, modern light sources, such as fluorescent light sources and LED's, generally have a chromaticity that is far from the black body curve. Thus, estimating the chromaticity coordinates of the ambient light illuminating the scene, and not only the correlated color temperature as according to prior art, will become more important under artificial modern lighting which is tailored for mood setting. Furthermore, it should also be noted that the correlated color temperature is less accurate as the chromaticity coordinate, as several chromaticity coordinates make up a correlated color temperature line. In comparison, the color point is a point and thus more precise.

In a preferred embodiment, the scene information is a two-dimensional information vector comprising at least two color channels, and the determination of the chromaticity coordinates includes finding maximum values for each of the at least two colors channels in the scene information. That is, if a scene has a perfect white diffuse reflector or objects that are perfect diffuse reflectors in at least the part of the spectrum that corresponds to the filter sensitivities of a camera, this approach produces a good estimate of the chromaticity of the illuminant. Variants of the method that correct for non diffuse reflections include detecting specularities and fluorescent materials in the scene and removing the information given by those pixels. Therefore, to be able to implement the improvements, all the pixels are needed and not only one value given by an additional sensor. This approach for determining the chromaticity coordinates is sometimes referred to as the Retinex approach, and for example disclosed in “A Comparison of Computational Color Constancy Algorithms; Part One: Methodology and Experiments with Synthesized Data” and “A comparison of color constancy algorithms. Part Two. Experiments with Image Data”, IEEE Transactions in Image Processing volume 11 number 9, pages 972-984 and 985-996, IEEE, 2002, Kobus Barnard and Vlad Cardei and Brian Funt.

In another preferred embodiment, the determination of the chromaticity coordinates includes summarizing and averaging each of the at least two color channels in the scene information, i.e. based on the majority of pixels comprised in the scene. For many natural scenes the average of the object colors tends to be a neutral gray (the gray world assumption) and in such cases the chromaticity of the average is a good estimate of the scene illuminant Building a two dimensional (2D) or three dimensional (3D) histogram and averaging only the non-empty bin centroids relaxes the assumption. A single ambient illumination sensor averages all pixels, so again having the information for all the pixels from the camera enables additional improvements. Furthermore, it would also be possible to use spatial information comprised in the scene information is used to determine the chromaticity coordinates, thereby further enhancing the determination step. The processing of the scene information for example in building a histogram can be done for example in any of the following color spaces: CIE XYZ, CIE xyY, CIE L*a*b*, CIE L*u*v*, CIE Lu'v' , device RGB, standard RGB as sRGB, device rg or standard RGB derived rg, YRcCb, YUV. The above list is by no means exhaustive and the usage of other possible color spaces can be done in a similar manner.

The image sensor is preferably selected to be for example a CMOS or a CCD image sensor. The image sensor used may however depend on the cost segment, where the CMOS sensor generally is cheaper but than also potentially, presently, provide a result having lower quality than a CCD sensor. The image sensor is preferably adapted to capture at least two colors, and more preferably three colors, however, multiple monochromatic imagers and filters can be used. Suitable three-color filters are well known to the skilled addressee, and, in some cases are incorporated with the image sensor to provide an integral component.

Preferably, the method further comprises the step of mixing the light from the at least two differently colored light sources, thereby preventing color shadows in the illuminated scene. The color mixing can be achieved by using a combination of collimators and reflectors. Other mixing possibility includes using diffusers, e g running the light through a scattering medium, or by using a light guide with random reflection patches.

The method according to the present invention is also preferably combined with the use of a pre flash for estimating the chromaticity of the environmental light, where the pre-flash is used to set the white balance and other camera settings before the picture is taken. For example, it would be possible to use the pre flash to determine the chromaticity of the ambient lighting conditions using a pixilated image of the scene and determine the flash settings according to the ambient light settings. It is also possible, and within the scope of the invention, to compare two consecutive images, where the first image is taken using the illumination of a predetermined and well defined pre-flash. The comparison result is then subsequently used for further enhancing the step of determining the chromaticity coordinates of the scene.

According to a further aspect of the invention, there is provided an illumination device for illuminating a scene having an average lighting setting, the illumination device comprising at least two differently colored light sources, and a control unit adapted to receive scene information from an image sensor comprising a plurality of pixels, determine chromaticity coordinates for the scene based on the scene information, and determine, based on the chromaticity coordinates, control values used for driving the at least two light sources, thereby allowing for illumination of the scene without essentially changing the average lighting setting of the scene. This aspect of the invention provides similar advantages as according to the above discussed method, including the possibility to provide a better representation of the color of ambient light illuminating the scene than when using the correlated color temperature.

The control unit can further be adapted to receive an information signal from a spectral detector. By further adapting the control unit for taking additional spectral information into account it is possible to provide improved spectral measurement of the light in the scene and/or for optimizing the color rendering of the illumination device for a certain desired/predetermined color point.

Preferably, the illumination device according to the present invention is used as a flash unit together with a camera. The camera can for example be an analog camera or a digital camera.

In a preferred embodiment, the at least two differently colored light sources comprises a multi color light emitting diode (LED) array having a high color rendering index. The use of LEDs provides further advantages as they have spectra far from the black body curve and thus are better controlled based on the chromaticity coordinates of the scene to be illuminated.

However, the skilled addressee would appreciate that it of course would be possible to use different kind of light sources, preferably selected from a group comprising organic light emitting diodes (OLEDs), polymeric light emitting diodes (PLEDs), inorganic LEDs, cold cathode fluorescent lamps (CCFLs), hot cathode fluorescent lamps (HCFLs), plasma lamps. Furthermore, LEDs generally have a much higher energy efficiency in comparison to conventional light bulbs which generally deliver at best about 6% of their electric power used in the form of light. However, it would of course be possible, and within the scope of the invention to use standard incandescent colored light sources, such as argon, krypton, and/or xenon light sources. However, in an even more preferred embodiment, the multi color LED array comprises at least one red LED, at least one green LED, at least one blue LED, at least one yellow LED, at least one magenta LED, and at least one cyan LED. Also, it would be possible to include means for synchronization of illumination device with the capturing of the picture. When using LEDs, it is essential that the illumination time provided by the illumination device and the image acquisition time for the camera are synchronized in such a way as to allow the full light of the combined ambient light, the light from the illumination device according to the present invention, and possibly other light sources that are reflected of the scene and captured by the camera.

The illumination device according to the present invention is preferably, but not exclusively, used as a component in a camera further comprising an image sensor. In such an arrangement, the image sensor is preferably used for capturing the scene information provided to the illumination device. The camera can for example be integrated with a mobile telephone.

### BRIEF DESCRIPTION OF THE DRAWINGS

These and other aspects of the present invention will now be described in more detail, with reference to the appended drawings showing currently preferred embodiments of the invention, in which:

FIG. 1 is a block diagram illustrating an electronic flash unit according to an embodiment of the present invention;

FIG. 2 is a flow chart showing the steps of a method according to an embodiment of the present invention;

FIG. 3 illustrates a camera arrangement comprising a camera and an electronic flash unit according to an embodiment of the present invention; and

FIG. 4 is an exemplary diagram illustrating the synchronization of the light sources of a flash unit with the capturing of an image.

### DETAILED DESCRIPTION OF CURRENTLY PREFERRED EMBODIMENTS

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled addressee. Like reference characters refer to like elements throughout.

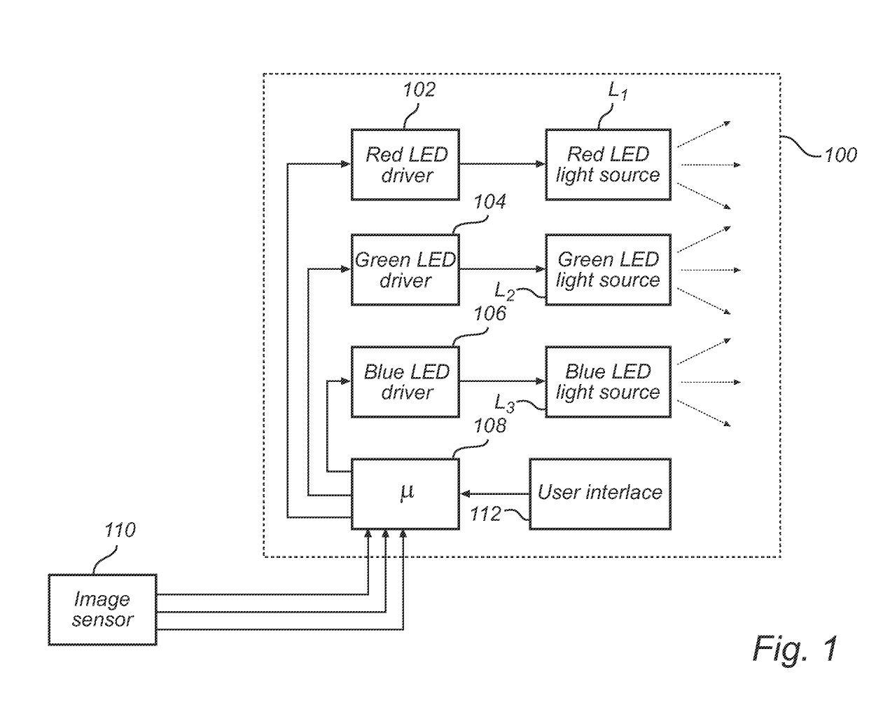

Referring now to the drawings and to FIG. 1 in particular, there is depicted a block diagram of an electronic flash unit 100 adapted to provide adjustable color illumination and arranged in accordance with a currently preferred embodiment of the present invention. In the exemplary embodiment, the electronic flash unit 100, i.e. generally denoted illumination device, comprises three LED light sources of the colors red L₁, green L₂ and blue L₃, each connected to a corresponding driver circuit 102, 104 and 106. As understood by the skilled addressee, it is of course possible to use more that three differently colored light sources. Furthermore, it would be possible to use either single light sources or individually controlled groups of light sources of the same color. The LEDs L₁-L₃ together provides light having a high color rendering index. Also, for further increasing the color rendering index, the electronic flash unit 100 can comprise further LEDs, for example of at least one of the colors yellow, magenta and cyan.

The driver circuits 102, 104, 106 are in turn controlled by a control unit 108 which is adapted to receive scene information from an image sensor 110 comprising a plurality of pixels. The image sensor 110 is preferably at least one of a CMOS or a CCD image sensor, however, present and further digital image capturing means are possible and within the scope of the present invention. The image sensor 110 generally provides the scene information by means of three color channels, e.g. one green, one red and one blue color channel. Different methods are possible, including the use of a Bayer mask over the image sensor 110. In this case, each square of four pixels has one filtered red, one blue, and two green, as the human eye is more sensitive to green than either red or blue. The result of this is that luminance information is collected at every pixel, but the color resolution is lower than the luminance resolution. However, it is also possible to combine three image sensors and use a dichroic beam splitter prism that splits the image into red, green and blue components. In this case, each of the three image sensors are arranged to respond to a particular color.

The control unit 108 may include a microprocessor, a microcontroller, a programmable digital signal processor or another programmable device. The control unit 108 may also, or instead, include an application specific integrated circuit (ASIC), a programmable gate array, a programmable array logic, a programmable logic device, or a digital signal processor. Where the control unit 108 includes a programmable device such as the microprocessor or microcontroller mentioned above, the processor may further include computer executable code that controls operation of the programmable device.

The control unit 108 can also be adapted to include means for receiving information from a user through a user interface 112. The user interface 112 may include user input devices, such as buttons and adjustable controls, which produce a signal or voltage to be read by the control unit 108. The information provided by the user through the user interface 112 can for example include detailed information about the scene, the type of camera used together with the electronic flash unit 100, or similar information. The control unit 108 will determine, based on the scene information provided by the image sensor 110 (e.g. a digital picture of the scene), the chromaticity coordinates for the scene, and provide drive signals to the respective driver circuits 102, 104, 106 corresponding to the chromaticity coordinates for the scene. The driver circuits 102, 104, 106 in turn drive each of the LEDs L₁-L₃. The control unit 108 can control the LEDs L₁-L₃ for example by using pulse width modulation (PWM), which regulates the relative intensities and thereby the mixing ration of the LEDs L₁-L₃. By controlling the time an LED is turned on and off, and doing so fast enough, the LED will appear to stay on continuously. However, as the electronic flash unit 100 according to the invention preferably is used as a flash for a camera, the electronic flash unit 100 will generally be arranged to deliver a powerful illumination flash (e.g. 3-10 times the normal burning power) during a short time period which typically is around 1/3000 of a second. Alternatively to controlling the LEDs using PWM, it is also possible to drive the LEDs L₁-L₃ by analog adjustment of the amount of current supplied to the LEDs L₁-L₃ using the respective driver circuits 102, 104, 106.

Different algorithms are possible to use for the determination of the chromaticity coordinates, and preferably at least one of the Retinex algorithm or the gray world approach is used. However, other algorithms, including for example different gamut mapping method, neural network algorithms, or fuzzy heuristic methods are possible and within the scope of the present invention. For example, the gamut mapping method includes the determination of the chromaticity coordinates present in the scene (the scene gamut) to a set of colors (neutral color gamut) under a most likely illuminant. Also, by color by correlation and related algorithms the determination of the chromaticity coordinates includes estimating the likelihood of the colors present in the scene being part of a scene under a certain illuminant. Other examples include specular and shadow methods, where the determination of the chromaticity coordinates includes determining shadows or specular reflections in the scene. Furthermore, the control unit 108 can also, alternatively (not illustrated), be adapted to receive an information signal from a spectral detector.

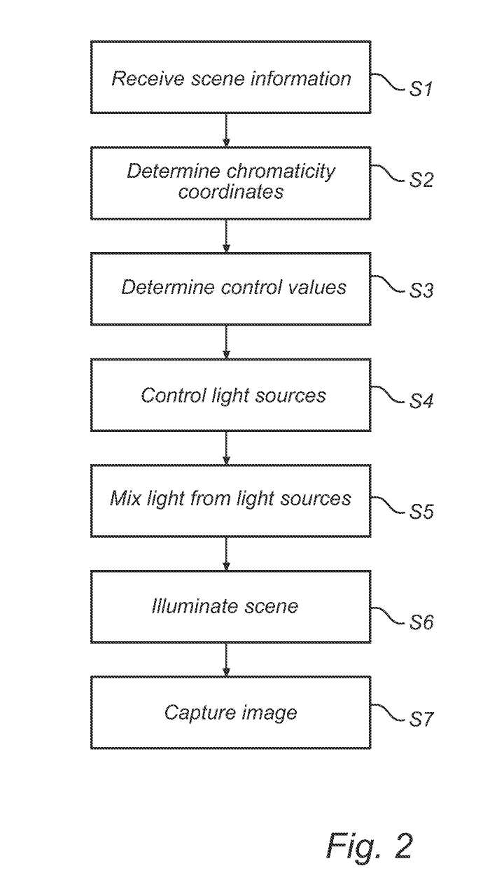

The method according to the present invention performed by the electronic flash unit 100 as described above is summarized in FIG. 2, comprising the steps S1-S6 of receiving scene information, determining chromaticity coordinates, determining control values, controlling the LEDs, mixing the light from the LEDs, illuminating the scene. Preferably, the step of capturing an image, S7, is also included.

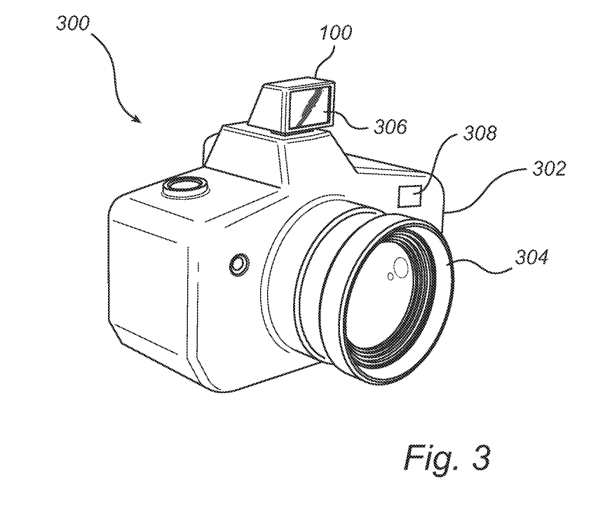

FIG. 3 illustrates a camera arrangement 300 comprising a camera 302 and an electronic flash unit 100 according to the present invention. Generally, it is according to the present invention possible to use one of a photo camera and a video camera, where the camera is either digital or analog. The camera 302 can also be integrated in a mobile phone having camera capability. In the illustrated embodiment the camera 302 is a digital camera, and an image sensor of the camera is used for providing the scene information to the control unit 108. The camera 302 comprises optics 304, a display for showing captured images (not visible in FIG. 3), and further components known in the art.

In the illustrated embodiment, the electronic flash unit 100 is provided as a separate unit mounted on top of the camera 302 at a small distance, thereby preventing direct reflections from the electronic flash unit 100 as is possibly the case when integrating the electronic flash unit 100 with the camera 302. However, the skilled addressee still understands that the camera 302 can be incorporated with the electronic flash unit 100.

Furthermore, in the illustrated embodiment the electronic flash unit 100 is provided with a color mixing device 306 arranged in front of the LEDs L₁-L₃. The color mixing device 306 is provided for reducing, and preferably removing, color shadows generated when mixing differently colored light sources. The color mixing device 306 preferably comprises a combination of collimators, reflectors, and or diffusers.

Similarly to the discussion above, the camera 302 includes a distance/focus sensor 308 (which can be similar as the flight sensor 114 in FIG. 1) arranged to provide a distance to an object such that the lens can be adjusted such that a clear focus is obtained. The sensor 308 can also be used in the determination of the chromaticity coordinates used when determining the drive signals for the LEDs L₁-L₃.

The distance/focus sensor 308 can also be used for synchronizing the light illuminated by the electronic flash unit 100 with the camera 302 capturing an image of the scene. However, it would also be possible to use auto focusing features of the camera 302 to determine the distance to the, possibly main object, in the scene, and use this distance measurement for synchronizing the flash with the capturing of the picture, or for adjusting the intensity of the flash for providing optimal color reproduction. In relation to the underwater use of the electronic flash unit 100, the control unit 108 can further be adapted to receive a signal representative of the current depth, and use this signal for provide further enhancements to the illumination of the scene.

When using the flash unit 100 together with a camera 302, it is important to synchronize the image capture time with the modulation scheme that is used to drive the LEDs. Typically, LEDs L₁-L₃ can be driven in a variety of modulation modes, such as for example pulse width modulation (PWM), frequency modulation (FM), amplitude modulation (AM) or similar control methods.

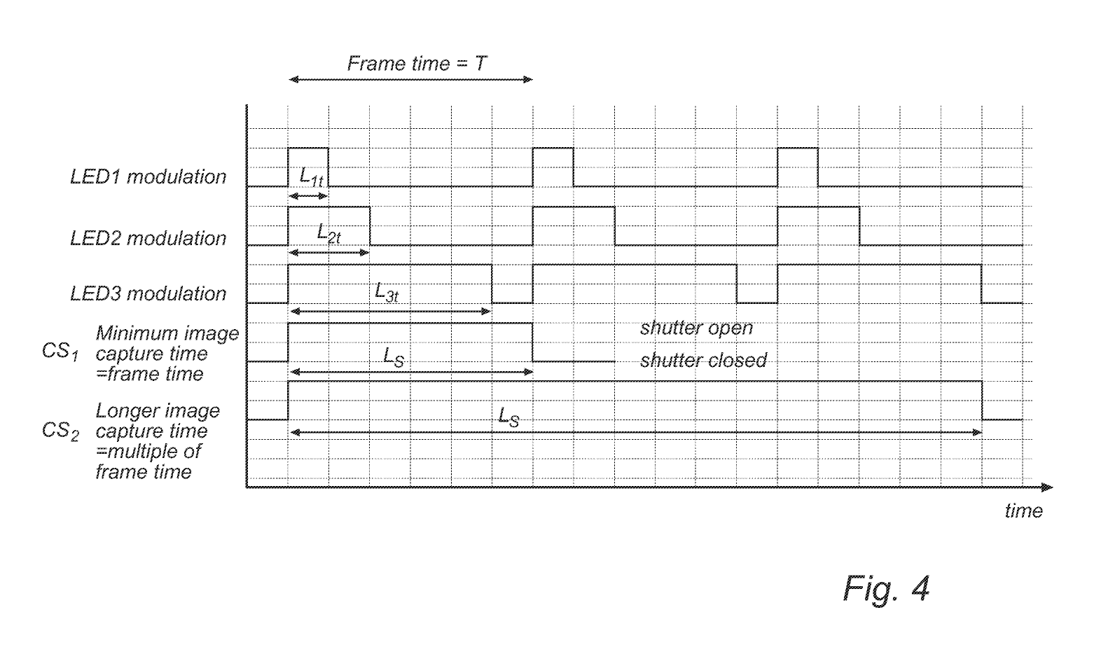

In the case of PWM, the drive current of the LEDs is modulated between zero current and a certain fixed current level. This is done to maintain a color consistent operation of the LEDs, while at the same time allowing dimming of the LEDs. The spectral output of LEDs depends on the drive current which is kept constant by always employing the same drive current level. The dimming is achieved by changing the pulse width of the current drive, i.e. the duty cycle at which an LED is operated (i.e. ratio between the time the LED is active in comparison to the period, denoted T, for the modulation frequency). For a multi-LED system each LED has a different duty cycle in order to achieve the desired mixed color point. In this case, it is generally required that the capture time of the image sensor is synchronized with the period T or an integer multiple of the period T, for the modulation frequency at which the pulse width modulation of the LEDs is operated (i.e. the LED drive scheme). This is illustrated in FIG. 4, providing an exemplary diagram illustrating the synchronization of the light sources (e.g. L₁-L₃) of a flash unit with the capturing of an image for example using the camera 302. In the diagram, the active time for each of the LEDs L₁-L₃ are different, where the LED L₃ has the longest duty cycle. In the diagram, two different capturing sequences are illustrated, denoted CS₁ and CS₂. The two capturing sequences illustrate the synchronization with one modulation period and a multiple of duty cycles, respectively. Thus, in the first case, CS₁, the shutter time Lₛ (also referred as the image acquisition time) equals one modulation period, 1*T, and in the second case, CS₁, the shutter time Lₛ equals a plurality, N, of modulation periods N*T.

In the case of frequency modulation also synchronization is required. In frequency modulation, the pulse height and width of the drive current is fixed, and the occurrence of these pulses in a certain total time frame determines the overall intensity of the LED driven with this scheme. To get the correct color representation during image capture in this case, it is required that the image capture time is equal, i.e. synchronized with the total time of the frequency modulated drive signal.

In a preferred embodiment of the current invention a combination of pulse width modulation (PWM) and amplitude modulation (AM) is applied. That means as long as the pulse lengths L₁ₜ, L₂ₜ, L₃ₜ for each of the respective LED L₁, L₂, L₃ is smaller or equal to the length of the shutter time Lₛ PWM is applied. If the controller calculated light settings in which one or more of the light pulses L₁ₜ, L₂ₜ, L₃ₜ would become longer than Lₛ, the controller switches to AM, i.e. the light amplitude is increased by increasing the current through the LED in a way that the integral light intensity from that light source during Lₛ is set according to the requirements. (Higher intensity and shorter pulse width.)

In another preferred embodiment at least a few of said light sources are phosphor converted LEDs. This has been found to be very suitable especially for amplitude modulation driving.

Also, it would be possible, and within the scope of the invention, to further enhance the illumination of the scene by comparing two pre pictures or auto focus measurements (one without flash and one with a white pre flash light). Objects that appear white in the pre-flash but colored in the non-flashed, could indicate the color of the natural illumination setting, which could be mimicked by the color temperature adapted electronic flash unit as disclosed through the invention.

Furthermore, it would be possible to detect a white point by looking at almost equal RGB levels within a pixel (or preferably an extended pixel area) with a certain intensity threshold. In order to find a real white object it is necessary to overcome the problem that there is most likely some atmosphere light in the scene (e.g. red light) and the image sensor 110 will detect the superimposed reflected light from both the flash and the atmosphere, which hampers easy white detection depending on the light intensities. Even further, it would also be possible to adapt the light intensity from the electronic flash unit 100 to the minimum needed level to realize light setting as natural as possible. Still further, the flash unit can comprise temperature sensing and/or temperature controlling means for providing better control over the chromaticity of the flash light. However, and as known by the skilled addressee, there are several additional feedback methods available for stabilizing the color point of individual LEDs, including for example color point feedback for improving the stability of the chromaticity of the LEDs.

In conclusion, it is according to the present invention possible to provide a novel method for that in a more precise way match the average lighting setting of the scene, wherein it is possible to produced light that assure a more natural rendering of illuminated objects in the scene. In comparison to the prior art, for light sources which have spectra far from the black body curve, the chromaticity coordinates are a better representation of the color of ambient light illuminating the scene than when using the correlated color temperature.

Furthermore, the skilled addressee realizes that the present invention by no means is limited to the preferred embodiments described above. On the contrary, the skilled addressee understands that many modifications and variations are possible within the scope of the appended claims. For example it would be possible to combine the method and device according to the present invention with various face detection algorithms known in the art for achieving even better illumination of the scene. Furthermore, for underwater use, the camera and the electronic flash unit according to the invention can be provided as separate units, and be connected to each other with an electrical interface. The electrical interface can be wireless or achieved via a waterproof electrical cable. An advantage with a camera arrangement, for example in relation to underwater photography, is that it would be possible to take photos or record video without the cumbersome use of color correction filters.

1. A method for illuminating a scene having an average lighting setting, the method comprising the steps of;
receive scene information from an image sensor comprising a plurality of pixels;
determine chromaticity coordinates for the scene based on the scene information; and
determine, based on the chromaticity coordinates, control values used for driving the at least two differently colored light sources (L₁, 1₂, L₃), thereby allowing for illumination of the scene substantially without changing the average lighting setting of the scene.

2. Method according to claim 1, further comprising the step of representing color information comprised in the scene information as a multidimensional color histogram in digital color representation space.

3. Method according to claim 1, further comprising the step of representing color information comprised in the scene information as a three dimensional color histogram.

4. Method according to claim 1, further comprising the step of representing color information comprised in the scene information as a two dimensional chromaticity histogram.

5. Method according to claim 1, wherein spatial information comprised in the scene information is used to determine the chromaticity coordinates.

6. Method according to claim 1, wherein the determination of the chromaticity coordinates includes detecting at least one of a shadow or a specular reflection comprised in the scene information.

7. Method according to claim 1, wherein the scene information is a two-dimensional information vector comprising at least two color channels, and the determination of the chromaticity coordinates includes finding maximum values for each of the at least two colors channels in the scene information.

8. Method according to claim 1, wherein the scene information is a two-dimensional information vector comprising at least two color channels, and the determination of the chromaticity coordinates includes summarizing and averaging each of the at least two color channels in the scene information.

9. Method according to claim 1, wherein the method further comprises the step of mixing the light from the at least two differently colored light sources (L₁, L₂, L₃).

10. Method according to claim 1, wherein the method further comprises the step of estimating the chromaticity coordinates of the scene using a pre flash.

11. An illumination device for illuminating a scene having an average lighting setting, the illumination device comprising:
at least two differently colored light sources (L₁, L₂, L₃); and
a control unit configured to:
receive scene information from an image sensor comprising a plurality of pixels;
determine chromaticity coordinates for the scene based on the scene information; and
determine, based on the chromaticity coordinates, control values used for driving the at least two light sources (L₁, L₂, L₃), thereby allowing for illumination of the scene substantially without changing the average lighting setting of the scene.

12. Illumination device according to claim 11, wherein the scene information is a two-dimensional information vector comprising at least two color channels, and the determination of the chromaticity coordinates includes finding maximum values for each of the at least two colors channels in the scene information.

13. Illumination device according to claim 11, wherein the scene information is a two-dimensional information vector comprising at least two color channels, and the determination of the chromaticity coordinates includes summarizing and averaging each of the at least two color channels in the scene information.

14. (canceled)

15. Illumination device according to claim 11, wherein the at least two differently colored light sources comprises a multi color light emitting diode (LED) array.

16. Illumination device according to claim 15, wherein the multi color LED array comprises at least one red LED, at least one green LED, at least one blue LED, at least one yellow LED, at least one magenta LED, and at least one cyan LED.

17. Illumination device according to claim 11, wherein the control unit is further configured to receive a spectral information signal representative for the scene.

18-19. (canceled)
